(19) United States
(12) Patent Application Publication
(10) Pub. No.: US 2002/0147766 A1
(43) Pub. Date: Oct. 10, 2002

(54) Operating user profiles with distributed profile model using a hybrid terminal

(76) Inventors: Marko Vanska, Espoo (FI); Ian Nordman, Sipoo (FI); Mika Klemettinen, Helsinki (FI); Hannu Toivonen, Helsinki (FI); Antti Sorvari, Itasalmi (FI); Yka Huhtala, Helsinki (FI); Jukka-Pekka Salmenkaita, Helsinki (FI)

Correspondence Address: JAMES HWA, ESQ, MORGAN & FINNEGAN, L.L.P., 345 PARK AVENUE, NEW YORK, NY, 10154, US

(21) Appl. No.: 09/824,781

(22) Filed: Apr. 4, 2001

(51) Int. Cl. G06F 15/16

(52) U.S. Cl. 709/203; 709/205

(57) ABSTRACT

A system and method manages user privacy in a network environment through a distributed user system including a user device and profile operator. The management of user privacy involves recognizing one or more service opportunities of a service operator on a user device operated by a user, determining a privacy level at which communications is conducted with a service operator relating to the one or more service opportunities on the user device, determining a profile access level on the user device, transmitting the profile access level to the service operator, and enabling the service operator to obtain a subset of profile information of the user according to the profile access level.

### BACKGROUND OF THE INVENTION

1. Technical Field

The present invention is related to a method and system for managing a privacy level at which a user communicates with other parties and managing access and usage of the user's profile information by other parties.

2. Art Background

The rapid advancements in mobile technology as well as other communication technologies have lead to an information age in which consumers are increasing relying on electronic services accessible through a portable wireless devices. However, at the same time, consumers are becoming increasingly concerned over privacy issues and the dissemination of their personal information.

### SUMMARY

A method of managing user privacy in a network environment is disclosed. The method involves recognizing one or more service opportunities of a service operator by a user operating a user device. A privacy level, at which communications is conducted with a service operator, is then determined and communications with the service operator are conducted at the privacy level. Optionally, the discovery of the one or more service opportunities can be recognized automatically.

A further option anonymously obtains information relating to the one or more service opportunities. The information relating to the one or more service opportunities obtained in this manner can include a service category, a service description or a requested viewpoint. The service provider can be allowed to obtain access to a subset of profile information of the user according to the service category. In this manner, the service provider can provide personalized service to the user according to the subset of profile information. Alternatively, the service provider can be allowed to obtain access to a subset of profile information of the user according to the requested viewpoint. This option allows the service provider to provide personalized service to the user according to the subset of profile information.

The present method of managing user privacy in a network environment can include determined privacy levels including Anonymous, Pseudonymous, Anonymous transaction and Authenticated. Further, the privacy level is determined based on (1) the nature of the service negotiations with the service operator, (2) a level of privacy in one or more prior transactions with the specific service operator, (3) the identity of the service operator, based on user-defined parameters, or (4) the user's prior behavior or activity.

The method can also include obtaining a user identifier to conduct pseudonymous communications with the service operator relating to the one or more service opportunities. The method can also include allowing the service provider to obtain access to a predefined subset of profile information. The service provider can be charged a fee for obtaining the subset of profile information and the subset of profile information can be obtained from a location remote from the user device. If the subset of information is obtained remotely, the method can include allowing the service provider to determine a profile access level and can include transmitting the profile access level to the service operator. In this scenario, the service operator can obtain a subset of profile information of the user from a profile operator according to the profile access level. The profile access level can be determined from a service category of the one or more service opportunities or based upon a prior arrangement between the service operator and the user.

When the service provider obtains access to a subset of profile information, the method can further include updating the profile information of the user and can perform such an update on user information provided by the service operator. The user information would be derived from the service operator's interaction with the user during the service session. Optionally, the service operator can be compensated for providing such user information.

The method can further include tracking user activity on the user device and updating the profile information of the user based on the tracked user activity.

The method can further include the service provider dynamically changing the service opportunities recognized by the user, for instance, in accordance with the user's profile information.

The method can allow the user device and the service operator to communicate across a variety of networks, such as a wide are network (WAN) or personal area network (PAN). Further, the user device can be a mobile wireless device, service can be received from the service operator, and payment for the service obtained by the user can be conducted anonymously.

A method of managing user privacy in a network environment through a distributed user system including a user device and profile operator is also disclosed that recognizes one or more service opportunities of a service operator on a user device operated by a user, determines a privacy level at which communications is conducted with a service operator relating to the one or more service opportunities, determines a profile access level, transmits the profile access level to the service operator, and enables the service operator to obtain a subset of profile information of the user according to the profile access level.

### BRIEF DESCRIPTION OF THE DRAWINGS

FIG. 1A is an overview of a network system for enabling a user of a communication device to control a privacy level of communications with other parties and to control access and usage of the user's profile information by other parties in accordance with an advantageous embodiment;

FIG. 1B is a general overview of an example of different network arrangements between a user device and a service operator in the network system of FIG. 1A;

FIG. 2 is a block diagram of one example of the network system of FIG. 1A in which a user employs a Bluetooth-enabled mobile device to conduct service-related communications with a service operator through a fixed position Bluetooth-enabled wireless device;

FIG. 3A is an exemplary block diagram of the wireless user device of FIG. 2;

FIGS. 3B and 3C illustrate an exemplary high level architecture of components of the network system of FIG. 1A in which various application or function layers and sub-layers supported by the user device are shown;

FIG. 4 is an exemplary block diagram of a service operator;

FIG. 5 is an exemplary block diagram of a profile operator;

FIG. 6A is an overview of one example of an operator arrangement;

FIG. 6B is an overview of another example of an operator arrangement in which service operators may be hierarchically arranged to provide additional profile access levels or profile filtering;

FIG. 7A is an example of information maintained in a profile database by a profile operator;

FIG. 7B is an example of information maintained in a profile access authority database of a user device; and

FIGS. 8A through 8D illustrate an exemplary process by which a user device controls a privacy level of communications with a service operator and controls access and usage of the user's profile information by the service operator in accordance with an advantageous embodiment.

### DETAILED DESCRIPTION OF THE PREFERRED EMBODIMENTS

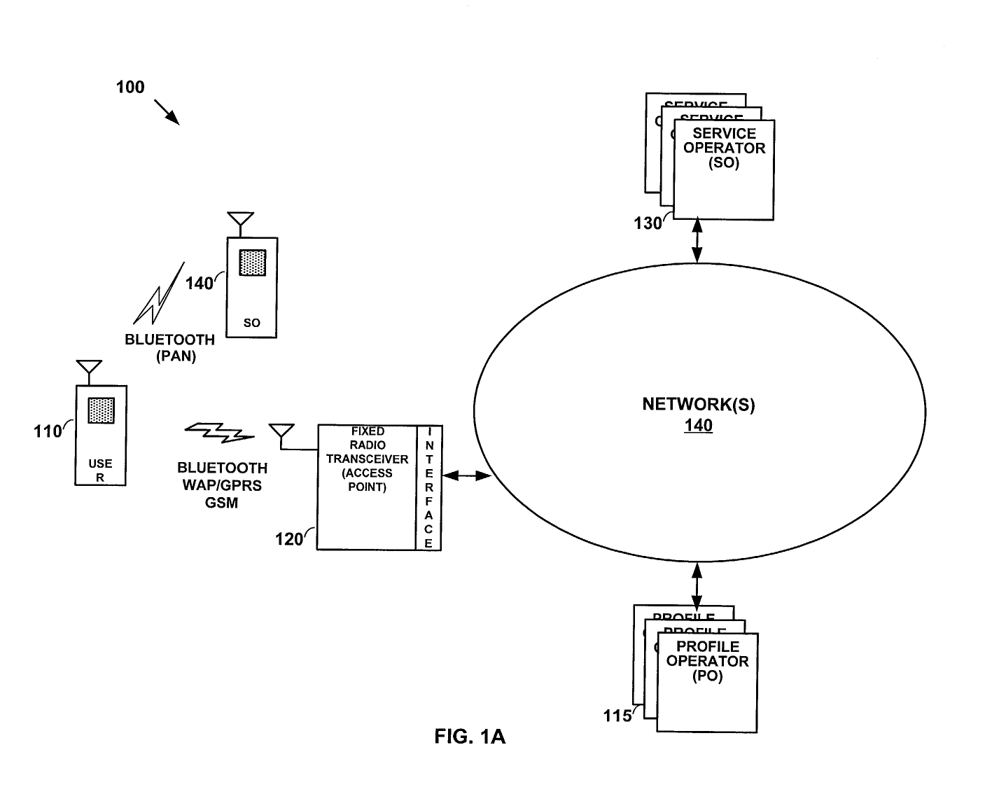

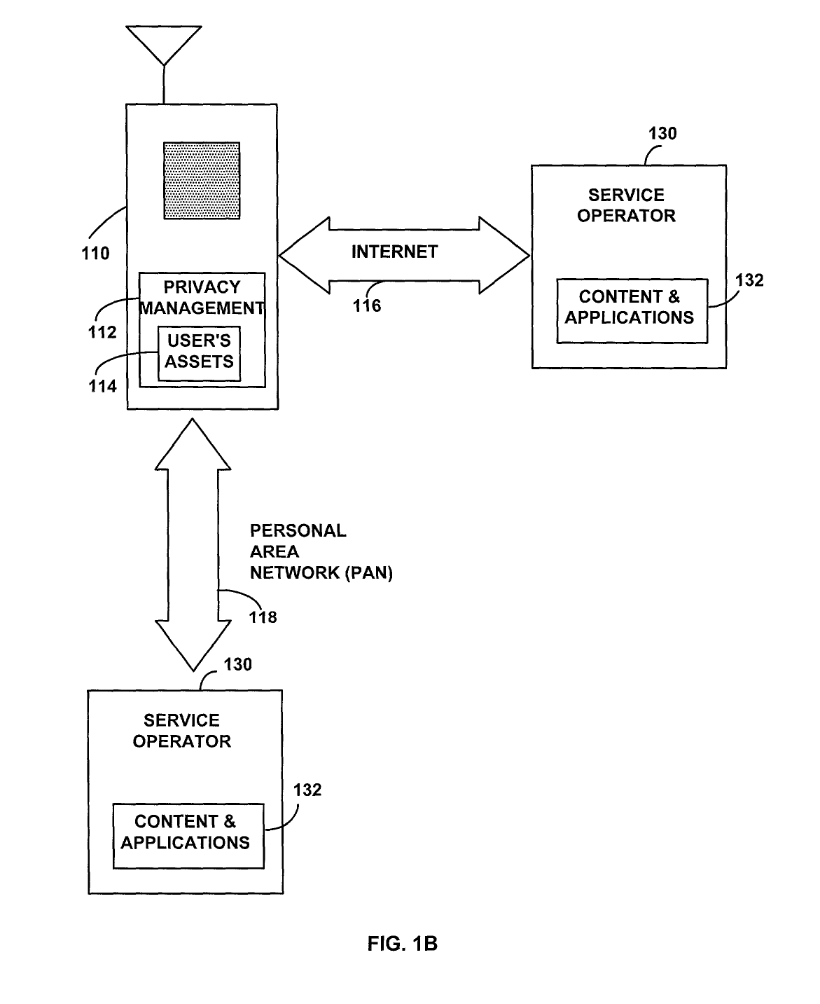

FIGS. 1A and 1B show an overview of a network system 100 for enabling a user of a communication device to control a privacy level of the user's communications with other parties and to control access and usage of the user's profile information by other parties in accordance with an advantageous embodiment of the present invention.

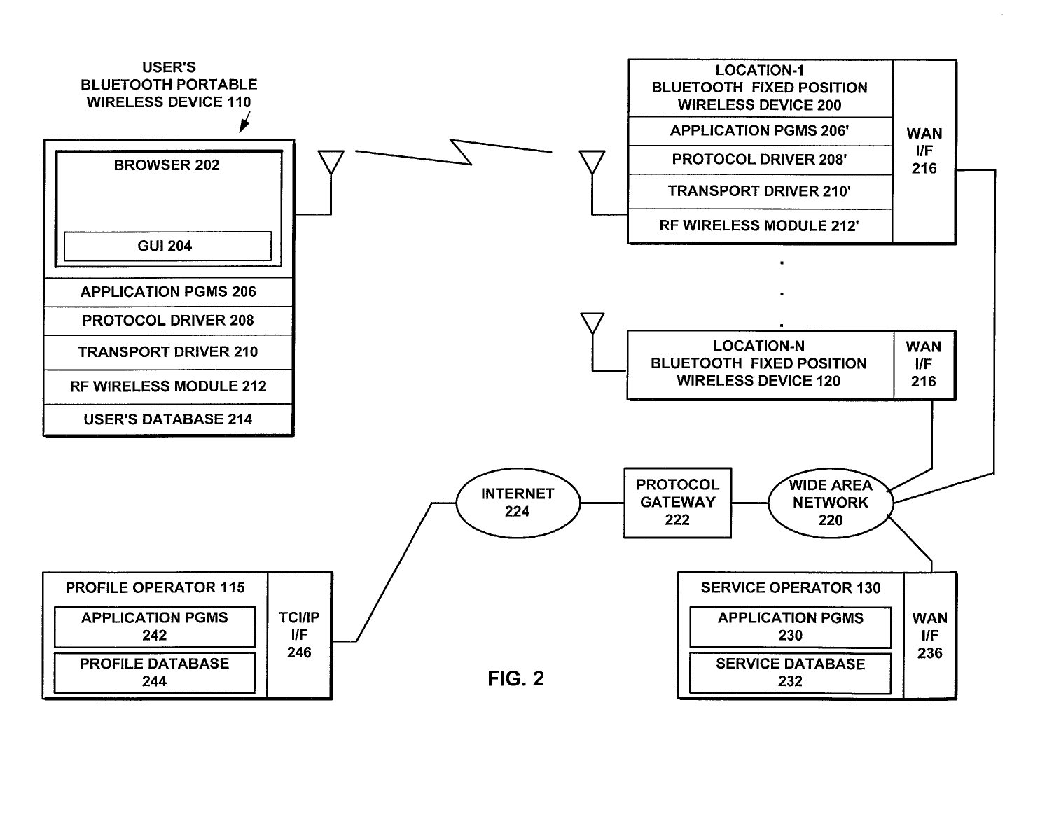

Network system 100 includes a user device 110 operated by a user, profile operator(s) 115 for maintaining the user's profile information, and a service operator(s) 130 for providing services to the user. User device 110, profile operator 115 and service operator 130 communicate with each other across network(s) 140. A radio transceiver 120 provides an access point to enable the user to conduct communications across network(s) 140. Network 140 may be a local area network(s) (LAN), wide area network(s) (WAN), the Internet, wireless network(s) or a combination thereof. Radio transceiver 120 may be, for example, a radio tower, a general packet radio service (GPRS) access point, a general system for mobile communications (GSM) access point or a fixed position wireless device implementing the Bluetooth™ standard. (“Bluetooth” is a trademark owned by Telefonaktielbolaget L M Ericsson, Sweden.). A detailed discussion of Bluetooth technology will be discussed below with reference to FIG. 2.

User device 110 may be any computerized system with communication means by which to conduct wire and wireless communications with other parties, such as service operator 130 and profile operator 110. In various embodiments, user device 110 may take the form of computer system or a mobile wireless device configured to perform the methods and processes discussed herein. For example, user device 110 may be a cellular phone, personal digital assistant (PDA), portable computer, handheld device, etc.

Service operator 130 may be any computerized system with communication means by which to conduct wire and wireless communications with other parties, such as user device 110 and profile operator 115. In various embodiments, service operator 130 may take the form of a server or computer system or a fixed or mobile wireless device configured to perform the methods and processes discussed herein. For example, service operator 130 may be a server of a retailer or a cellular phone, personal digital assistant (PDA), portable computer, handheld device, etc.

Profile operator 130 may be any computerized system with communication means by which to conduct wire and wireless communications with other parties, such as user device 110 and service operator 130. In various embodiments, profile operator 115 may take the form either as a server or computer system or a fixed or mobile wireless device configured to perform the methods and processes discussed herein.

As shown in FIG. 1A, user device 110 may conduct communications with service operator 130 or profile operator 115 using Bluetooth technology or general packet radio service (GPRS) or general system for mobile communications (GSM), or may conduct communications with a mobile service operator 140 using Bluetooth technology or the like to establish a personal area network (PAN).

In accordance with one embodiment, user device 110 is configured to control a privacy level of communications with another party, such as a service operator. The user or user device 110 on behalf of the user may determine which level of privacy should be maintained in an ad hoc or user initiated communications environment. In such environment, user device 110 may conduct the communications with another party at varied privacy levels, such as absolute anonymity (e.g., without any provision of a user identifier to the communicating party), with pseudonymity (e.g., with the use of a pseudonym) or with authenticated user identification. User device 110 may be set to operate at a default privacy level of anonymous.

For example, in a service environment, user device 110 may control the privacy level of communications with another party, such as service operator 130. The privacy level may be determined based on a user request or automatically based on the nature of the circumstances surrounding the communications. In the automatic implementation, user device 110 may adjust a privacy level, for example, based on the nature of the service negotiations with another party (e.g., service category or context), the level of privacy in one or more prior transactions with the specific service operator, the identity of service operator 130, user-defined situations, the user's prior behavior or activity (e.g., profile), and so forth. For the purposes of illustration, the service negotiations may be divided into four layers, i.e., layers one, two, three and four.

The first negotiation layer may involve an initial service inquiry or discovery, which does not require any identification of a user, e.g., a user ID. This may simply involve user device 110 scanning the environment in a very light and privacy protected way, and obtaining a response from service operator 130. The response may include a service name or identifier, type and definition. Such a negotiation generally occurs automatically without user interactions.

The second negotiation layer may involve, for example, the provision of user profile information to service operator 130 for service personalization. In this situation, user device 110 may provide service operator 130 with a pseudonym identifier. This identifier may be generated on a per session basis when conducting communications with service operator 130 (i.e., a session ID). In this way, service operators are prevented from collecting profile information individually for each customer.

The third negotiation layer may involve, for example, anonymous service delivery which may also include anonymous payment possibilities. In certain circumstances, service may still be rendered by service operator 130 without any need to disclose the identity of the user. For example, a user may conduct an anonymous service transaction to purchase an item at a point-of-sale. Anonymous payment may also be provided through an entrusted third party, such as profile operator 115.

The fourth negotiation layer may involve circumstances in which it is necessary for the user to provide identity authentication and user identification to obtain a service. One example would where be the user is accessing his/her banking service. Additionally, some service providers may simply require the full identity of the user in negotiating services.

User device 110 may perform privacy level determinations and changes at anytime, e.g., prior to, during or after a communication with another party, such as service operator 110. As discussed above, user device 110 may initiate such determinations and changes upon a user request or automatically.

In accordance with another advantageous embodiment, user device 110 may also control access and usage of the user's profile information by other parties depending upon the nature of the communications with those parties. For example, in a service environment, user device 110 recognizes one or more service opportunities of service operator 130, and determines a profile access authority or level to identify subsets or viewpoints of profile information which the service operator may access or obtain. The access level may be determined based on service-related information provided by service operator 130, such as a service category, service description, requested viewpoint, service operator identifier and so forth, or based on a user's pre-existing relationship with the service operator to provide an agreed upon or predefined subset of profile information.

In a further embodiment, the profile access control may be distributed between user device 110 (e.g., a mobile wireless device) and profile operator 115 (e.g., a server). In this case, profile operator 115 maintains the user's profile information. User device 110 may determine a profile access level to the user's profile information and transmit the access authority to service operator 130 which, in turn, requests and receives a subset of profile information from profile operator 115 according to the determined access authority.

In addition to distributing the functionality and capacity burdens associated with controlling access to a user's profile information, other functions and capacity burdens may be also be distributed to decrease the work load on the user device while providing additional functionality through the use of a partner computing system or server, such as profile server 115. Such an arrangement may be generally referred to as the “hybrid-terminal model”.

The idea is that a future handset is closer to a“dummy” X terminal than a “smart device” in the sense that the computational power and“intelligence” resides in the network, i.e., at a network-based server. This means that the majority of the storage capacity, as well as the computational capacity, would be stored in the network.

At the network-based server, the following examples of functions and features may be provided:

User profile and preferences, such as described above in connection with a Profile Operator

Calendar and other basic software with their user-specific data (synchronizable between multiple devices, e.g., download, update, use)

MIDI and other ringing tone library

Video and image library

Software library

At the handset, the following examples of functions and features may be provided:

Synchronizable copies of changing/updating information (calendar etc.)

Desired parts of ringing tone, etc., libraries as local copies, others downloadable

Required parts of the user profile or references/access rights information for different services

All the above would provide clear benefits for both the user, the device manufacturer and the service operator. For the user, it would mean that he/she would have access to the same information with all his/her devices, and he/she could benefit from the same personalization features. Also, with all of the new capacity and features, the device would still remain very small. For the device manufacturer, the hybrid terminal would offer possibilities to increase the terminal functionality without having to overcome the challenges of optimizing code for small footprint software, tacking issues such as memory requirements and device size, computational power, etc. Server-side part of the hybrid terminal would also probably lower the threshold of buying a new design device (or several devices), if maintaining and synchronizing the data does not prove to be too problematic. For service providers and other companies this would mean great possibilities to offer server-side software and, e.g., to act as trusted third-parties to maintain the personal server-side information (profiles, visibility rules, etc.) for each user.

In practice, when the user purchases a first handset (e.g., a mobile phone), the user would be provided server-side functionality and capacity including, for example, calendar, basic software, etc. The user may activate these functions through an agreement with a service operator. After activating the hybrid terminal, the user can select (to some extent based on the operator) the services and service providers the user wishes to use (e.g., profiling, additional software etc.).

Additional embodiments will be discussed below.

FIG. 1B is a general overview of an example of a network relationship between user device 110 and service operator 130 in accordance with one advantageous embodiment. User device 110 may be a wireless device capable of conducting communications and service negotiations with service operator 130 over the Internet 116 or a personal area network (PAN) 118.

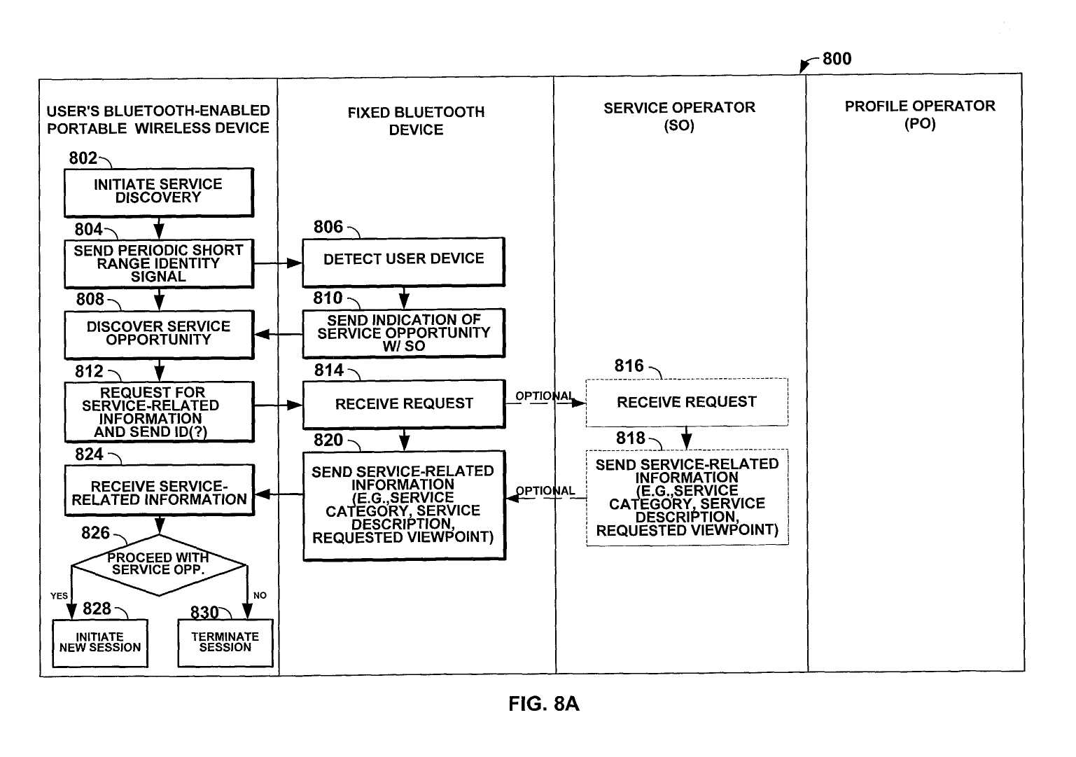

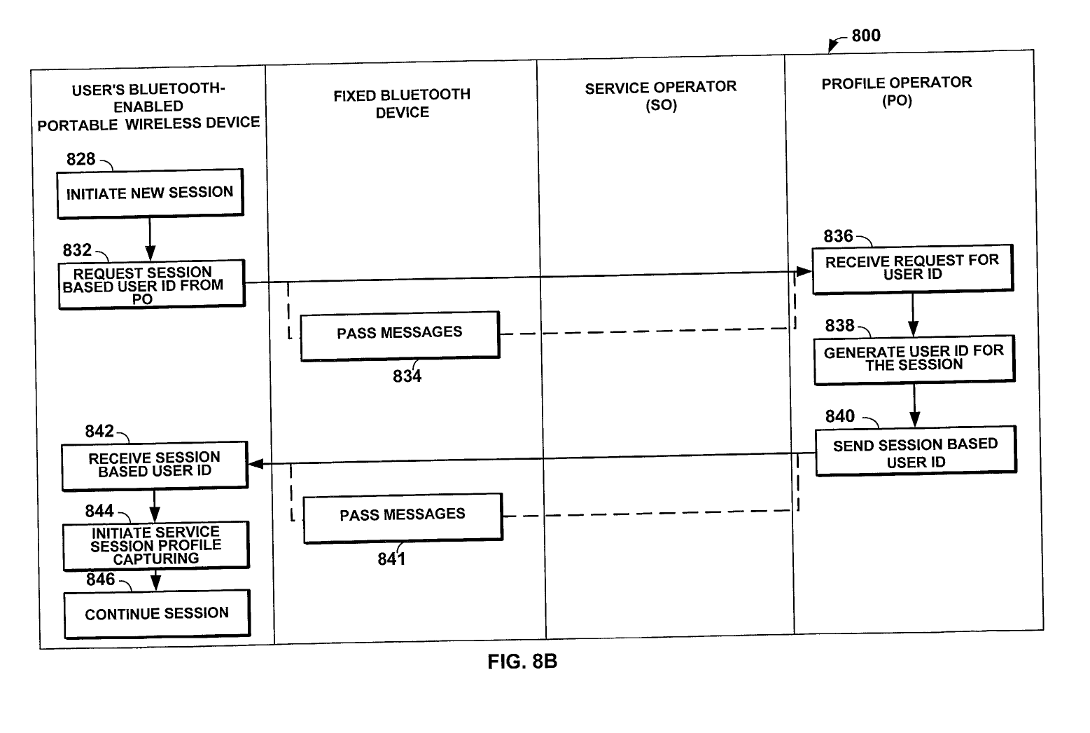

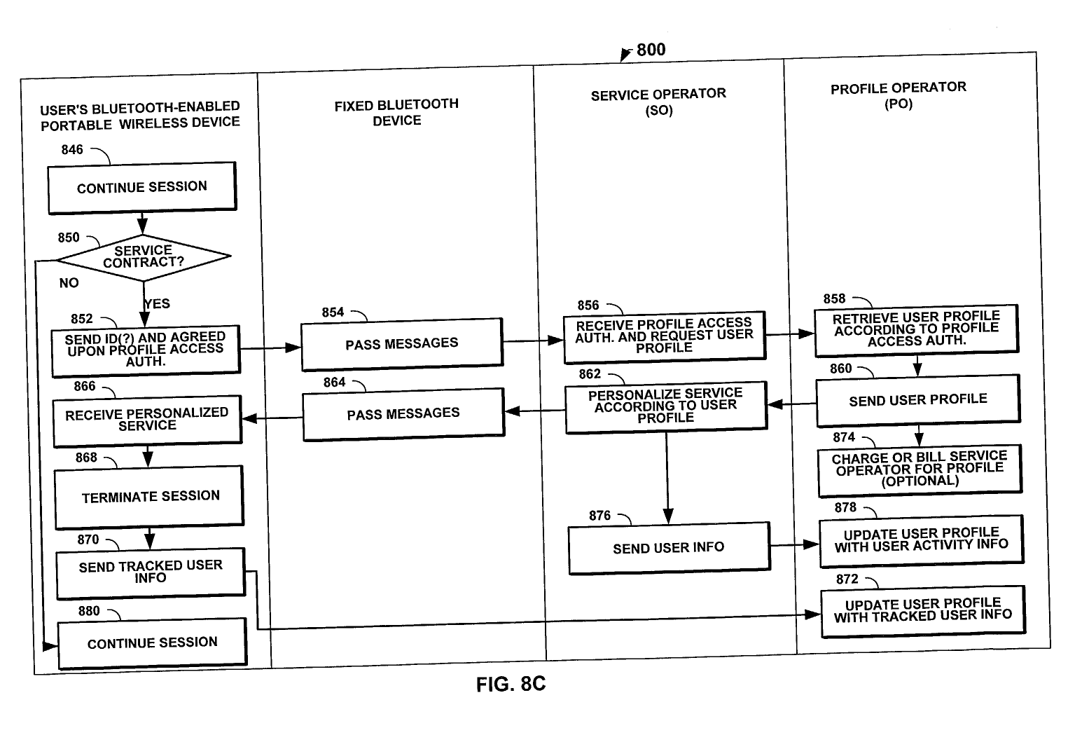

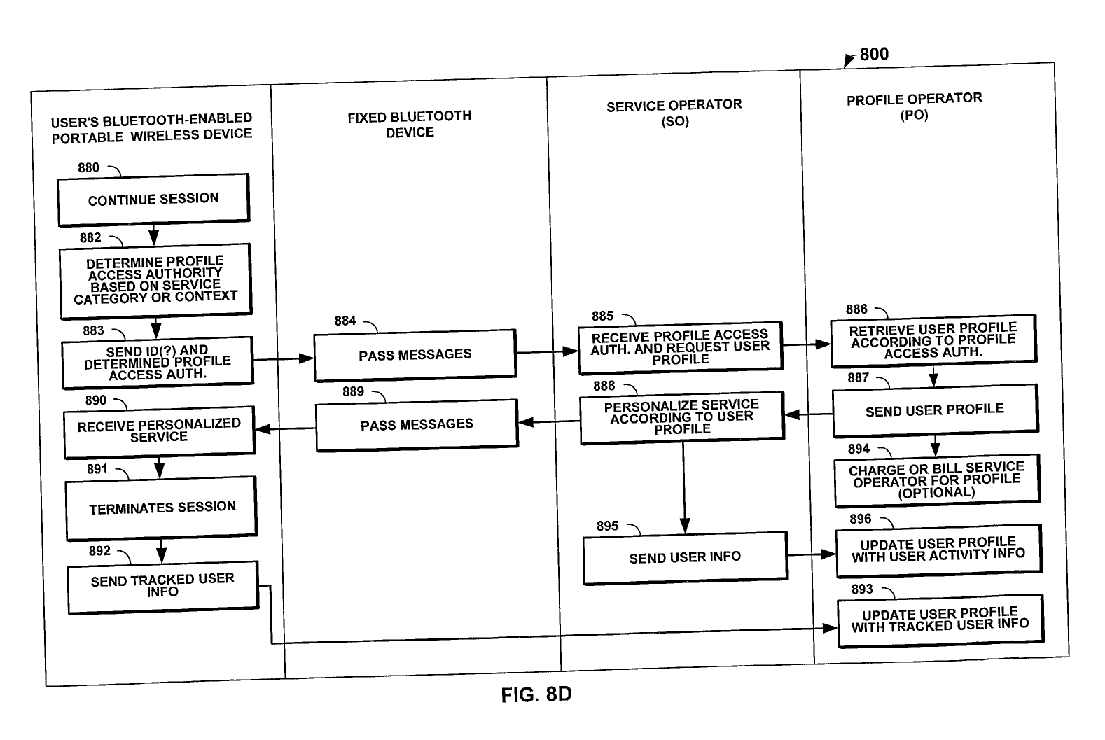

Service operator 130 may be a fixed or mobile wireless device or a server including content and application programs 132 for performing service negotiations with the user and providing a variety of services to the user. The manner in which service negotiations is performed with user device 110 is discussed in further detail below with reference to FIGS. 8A through 8D.

User device 110 may include a privacy management application program 112 for controlling the privacy levels (e.g., Anonymous, Pseudonymous, Anonymous transaction and Authenticated) at which the user conducts service-related communications with the service operator. As discussed above, the privacy level may be determined based on a user request or automatically based on the nature of the circumstances surrounding the communications. In the automatic implementation, user device 110 may adjust a privacy level, for example, based on the nature of the service negotiations with another party (e.g., service category or context), the level of privacy in one or more prior transactions with the specific service operator, the identity of service operator 130, user-defined situations, the user's prior behavior or activity (e.g., profile), and so forth. As one example, in a medical emergency, communications with the user's doctor would most likely be conducted on an authenticated basis.

FIG. 2 illustrates one example of a pervasive computing network system implementing the Bluetooth standard. The Bluetooth standard is a short-range wireless communication industry specification that allows portable, personal devices to interact which each other and other stationary devices. The Bluetooth standard uses the spread spectrum radio frequency and provides omnidirectional multiple connections without requiring communicating devices to be in line of sight. The maximum range is 10 meters, but it can be extended to 100 meters by increasing the power. When one Bluetooth device comes within range of another, they automatically exchange address and capability details. They can then establish a 1-megabit/second link with security and error correction. The device's radio operates on the globally available, unlicensed 2.45 GHz radio band, and supports data speeds of up to 721 Kbps. Each device has a unique 48-bit address similar to that provided in the IEEE 802 standard. Connections can be point-to-point or multipoint. Bluetooth devices are protected from radio interference by changing their frequencies randomly up to a maximum of 1600 times per second, using a frequency hopping protocol. They also use three different but complimentary error correction schemes. Built-in encryption and verification are provided. Bluetooth devices provide a universal bridge to existing data networks, a peripheral interface, and a mechanism to form small private ad hoc groupings of connected devices away from fixed network infrastructures. Bluetooth radio modules avoid interference from other signals by hopping to a new frequency after transmitting or receiving a packet.

The Bluetooth specification is a de facto standard containing the information required to ensure that diverse devices supporting the Bluetooth wireless technology can communicate with each other worldwide. The document is divided into two parts: Volume 1: Core, and Volume 2: Profiles. The Core part specifies components such as the radio, baseband, link manager, service discovery protocol, transport layer, and interoperability with different communication protocols. The Profiles part specifies the protocols and procedures required for different types of Bluetooth applications. A copy of the Bluetooth Specification can be downloaded from the Internet web site http://www.bluetooth.com/developer/specification/specification.asp . Additional information is provided in the book by Nathan J. Muller entitled “Bluetooth Demystified”, published by McGraw Hill, 2000 (ISBN 007-1363238).

In the network diagram of FIG. 2, an exemplary relationship is shown between a Bluetooth-enabled user device 110, a service provider's Bluetooth-enabled fixed position wireless device(s) 200 (hereinafter “fixed position device 200”) and service operator 130, and profile operator 115. Fixed position device 200, for example, may be arranged in a store to provide location-based shopping services or other services to the user.

User device 110 is shown having the form of a hand-held personal digital communicator, with an LCD display and a touch overlay screen to enable inputting commands to the microbrowser 202 by touching the portion of the screen displaying the appropriate input button. User device 110 includes a programmed central processor, a memory, at least a few alphanumeric input keys, and an RF wireless transceiver module 212. The memory of the user device 110 stores application programs 206, protocol driver 208, transport driver 210, and a user's database or assets 214.

User device 110 receives and sends data over a short radio link with fixed position device 200, for example. Microbrowser 202 displays a graphical user interface (GUI) 204 to enable the user to navigate through the pages of data being displayed and to select options that are presented by the microbrowser 202.

The Wireless Application Protocol (WAP) standard can be used in the application program layer 206 of user device 110, to provide functionality for the device's microbrowser 202. User device 110 accesses a small file called a deck which is composed of several smaller pages called cards which are small enough to fit into the display area of the device's microbrowser 202. The small size of the microbrowser 202 and the small file sizes accommodate the low memory constraints of the Bluetooth-enabled user device 110 and the low-bandwidth constraints of a wireless network. The cards are written in the Wireless Markup Language (WML) which is specifically devised for small screens and one-hand navigation without a keyboard. The WML language is scaleable from two-line text displays on a small screen microbrowser 202, up through graphic screens such as are found on personal communicators. The cards written in the WML language can include programs written in WMLScript, which is similar to JavaScript, but makes minimal demands on memory and CPU power of the user device 110 because it does not contain many of the unnecessary functions found in other scripting languages.

User device 110 includes a user database or assets 214 that stores the user's private data. Such data may include, for example, a profile access authority database 378, captured profile-relating information, privacy level parameters for identifying various situations requiring different privacy levels, and so forth.

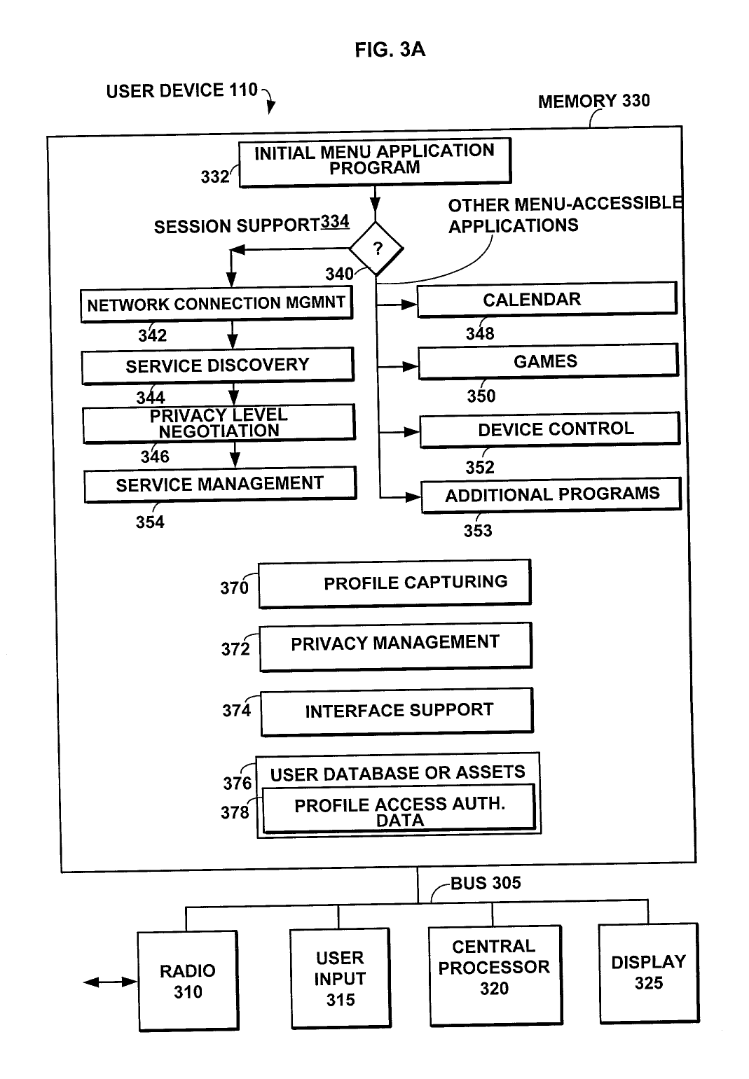

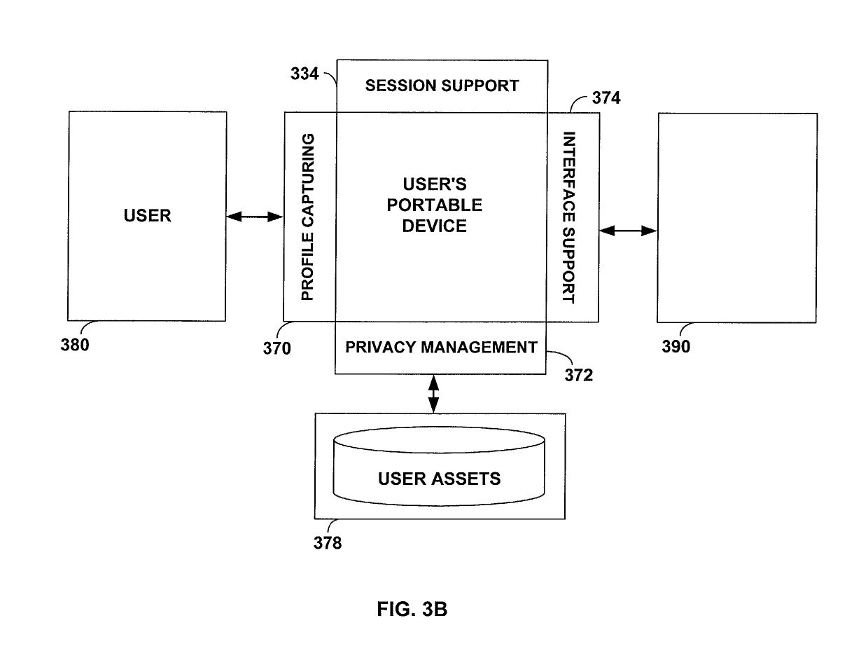

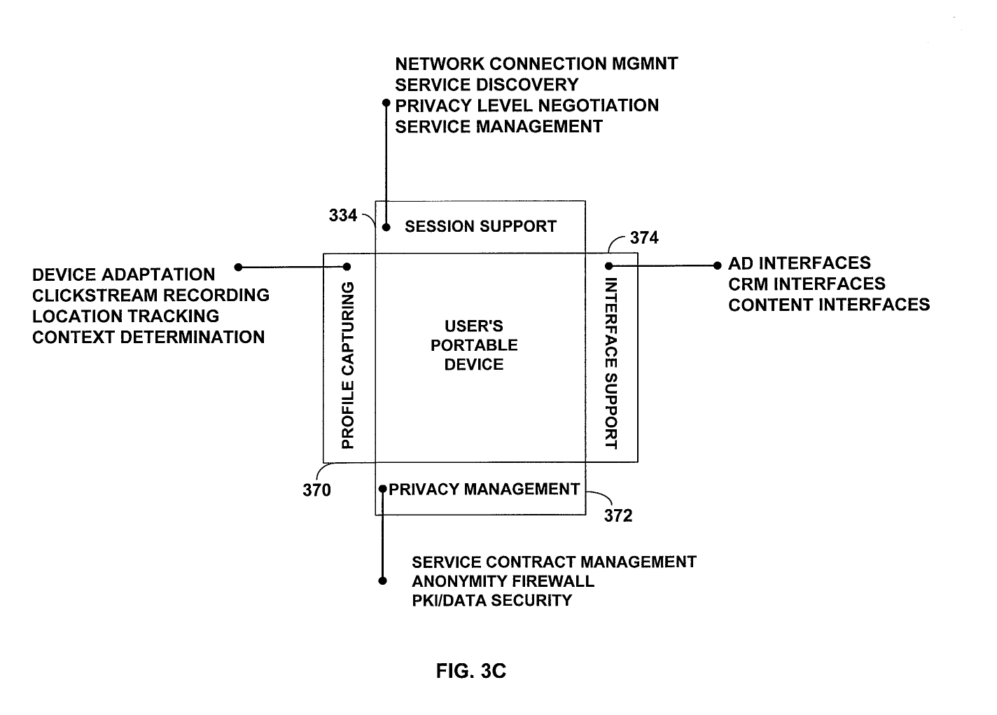

Application programs 206 in user device 110 are described in part below with reference to the flow diagrams of FIGS. 8A through 8D and the program descriptions to be provided below with reference to FIGS. 3A through 3C.

Protocol driver 208 in user device 110 includes the Bluetooth core protocols of Baseband, Link Manager Protocol (LMP), Logical Link Control and Adaptation Protocol (L2CAP), and Service Discovery Protocol (SDP) and the Bluetooth serial cable emulation protocol (RFCOMM). The Baseband and Link Control layers enable the physical RF link through RF wireless module 212, between the Bluetooth devices 110 and 200 forming a piconet RF network, coordinating the frequency-hopping spread spectrum system in which packets are transmitted in defined time slots on defined frequencies. A piconet RF network consists of one master Bluetooth device and up to seven active member Bluetooth devices. A Bluetooth network of multiple piconets is called a scatternet. The Link Manager Protocol (LMP) sets up the links between the Bluetooth devices 110. The Logical Link Control and Adaptation Protocol (L2CAP) provides data services to the upper layer protocols permitting them to transmit and receive data packets up to 64 kilobytes in length. The Service Discovery Protocol (SDP) enables a Bluetooth device 110 to discover available supporting services to enable it to connect to other Bluetooth device(s) 120. RFCOMM is an RS 232 serial emulation protocol that provides transport capabilities for upper level services that emulate a serial line as the transport mechanism. Other Bluetooth standard protocols can be included to support the applications of file transfer, Internet bridge, LAN access, information synchronization, multiple service provider telephony, and wireless headset functions. The Bluetooth protocol drivers 208′ in device 200 have similar features to those of the protocol driver 208.

Transport driver 210 in user device 110 includes the host controller firmware and a standardized interface to the RF wireless module 212. An example standardized interface is the RS232 serial device interface, enabling the exchange of control and data between the protocol driver 208 and the RF wireless module 212. Other standard interfaces for the Bluetooth transport driver 210 include the Universal Serial Bus (USB) and Universal Asynchronous Receiver-Transmitter (UART) protocols. The transport drivers 210′ in device(s) 120 have similar features to those of the transport driver 210.

In a shopping scenario, a store merchant possesses a Bluetooth-enabled fixed position device 200 which the merchant uses to communicate with the user. The merchant's Bluetooth-enabled fixed position device 200 includes application programs 206′, protocol driver 208′, transport driver 210′, and RF wireless module 212′.

Fixed position device(s) 200 and service operator 130 are connected by means of wide area network (WAN) interfaces 216 and 236, respectively, to a wide area network 220. Profile operator 115 is connected by means of TCP/IP interface 246 to Internet 224 which, in turn, is connected to wide area network (WAN) 220 across a protocol gateway 222.

FIG. 3A is an exemplary block diagram of a user device 110 of FIG. 2. As shown, user device 110 may include a radio transmitter 310, a user input 315, a central processor 320, a display 325 and a memory 330, which are connected across a bus 305. User device 110 may also include an interface for communicating across a line-based network.

Memory 330 stores an initial menu application program 332 for providing a menu of options to the user for selection and implementation of other application programs or routines according to the user selection. For example, menu application program 332 may initiate a session support application program 334 for supporting a session between the user and one or more other parties.

Session support application program 334 may include a network connection management routine 342, service discovery routine 344, privacy level negotiation routine 346 and a service management routine 354. Network connection management routine 342 is a process by which the user can be connected to Cellular Networks and Personal Area Networks (PAN) independently and by which the Bluetooth master and slave relationship can be determined. Service discovery routine 344 is a process which enables the user to activate or deactivate visibility to Bluetooth Access points (such as fixed position wireless devices) or enables the terminal to discover Bluetooth nodes in a PAN. Privacy level negotiation routine 346 is a process by which the user or the terminal on behalf of the user can determine which level of privacy should be maintained in an ad-hoc or user-initiated service context. As discussed above, the different levels of privacy may include Anonymous, Pseudonymous, Anonymous transaction and Authenticated. Service management routine 354 is a process by which the same service session can be maintained over several different network connections.

Initial menu application program 332 may also provide access to other menu accessible application programs, such as a calendar 348, games 350, device control 352 or other additional applications 353.

A user database or assets 378 is also maintained to store the user's private assets as well as other information. These assets may include, for example, profile preferences, rights wallet, presence information (e.g., context, device, location), and Personal Information Manager (PIM). Profile preferences involves a process for saving, storing and retrieving profile and preferences of a certain user, e.g., age, gender, social security number, shoe size, favorite food, loyalty card numbers, credit card numbers, etc. Rights wallet involves a process for saving, storing and retrieving rights belonging or given to a certain user, e.g., voting rights, access rights, etc., and the parameters to these, e.g., time, location, context, etc. Presence involves a process for saving, storing and retrieving context, device and location data of a given user. PIM involves a process for saving, storing and retrieving Personal Information data of a given user, e.g., calendar, e-mail, etc.

Memory 330 may further include additional application programs to facilitate the management of user privacy in communications with other parties. These programs may include a profile capturing program 370, a privacy management program 372, and an interface support program 374. These programs will be discussed with reference to FIG. 3C which illustrates a high level architecture of components of the network system 100 in which various application or function layers and sub-layers supported by the user device are shown.

As shown in FIG. 3C, profile capturing application program 370 provides a mechanism for capturing profile related information of the user. Profile capturing application program 370 may include various routines, such as device adaptation, clickstream recording, location tracking and context determination. Device adaptation is a process by which the content elements adapt to the user interface and presentation available in the terminal. The adaptation takes into account screen resolution, colors, free memory size and bandwidth available.

Clickstream recording is used for calibrating the middleware layer, i.e., for providing data to a recommendation engine or for optimizing menu structures. The end user should at any time be able to opt-out from recording or to review the data recorded from the clickstream.

Location tracking is used for calibrating the middleware layer, i.e., for providing data to a recommendation engine or for optimizing menu structures. The end user should at any time be able to opt-out from tracking or to review location data saved during consumption.

Context determination is used for calibrating the middleware layer, i.e., for providing data to a recommendation engine or for optimizing menu structures. Context determination parameters may be, for instance, time, content available at the given time and environment, altitude, heart beat rate, etc. The end user should at any time be able to opt-out from context determination or to review context data saved during interactive activities.

Furthermore, content adaptation within profile capturing is the mechanism for determining the mark-up language to be used, preferably, but not limited to, WML or XML.

As shown in FIG. 3B, profile capturing application program 370 interacts with user 380 to capture profile-related information. Privacy management application program 372 provides a security layer to access of a user assets 378, and interface support application program 374 enables user device 110 to interact with a service operator to obtain services provided through the service operator's content and applications 390.

The Service operator's content and applications 390 may include advertising platforms, content aggregation, CRM-Call Center Applications, one-to-one marketing, chat rooms, network games, and multimedia messaging. Advertising platforms may include Internet and mobile Internet advertising platforms. Content aggregation may involve a process of combining content from many sources into one service. CRM-Call Center Applications may involve a process for managing short term and context sensitive customer relationship data and retrieving it from CRM applications for calibrating middleware services. One-to-one marketing may involve service content profiling mechanisms using privacy levels. Chat rooms provide real-time person to person communication services using privacy levels. Network game includes real-time network gaming using privacy levels. Finally, multimedia messaging involves messaging with multimedia elements using privacy elements.

Privacy management application program 372 for managing security over the user's assets. Application program 372 may include various functions, such as service contract management, Anonymity and Public Key Infrastructure (PKI). Service contract management involves a process for determining the wishes of the consumer to lower the privacy levels and reveal certain viewpoints to the consumer assets in a certain service session. Anonymity is preferably the default level of privacy in the privacy management. The Public Key Infrastructure (PKI) is the method by which security is added to the privacy management.

Interface support application program 374 provides support for interacting with another party, such as a service operator. Interface support application program 374 may include various sub-functions, such as ad interfaces, Ubiquitous Customer Relations Management (UbiCRM) and content interfaces. Ad interfaces may include context, privacy, device and location sensitive Advertising platform interface mechanisms. CRM may include context, privacy, device and location sensitive CRM interface mechanisms. Content interfaces context, privacy, device and location sensitive Content interface mechanisms.

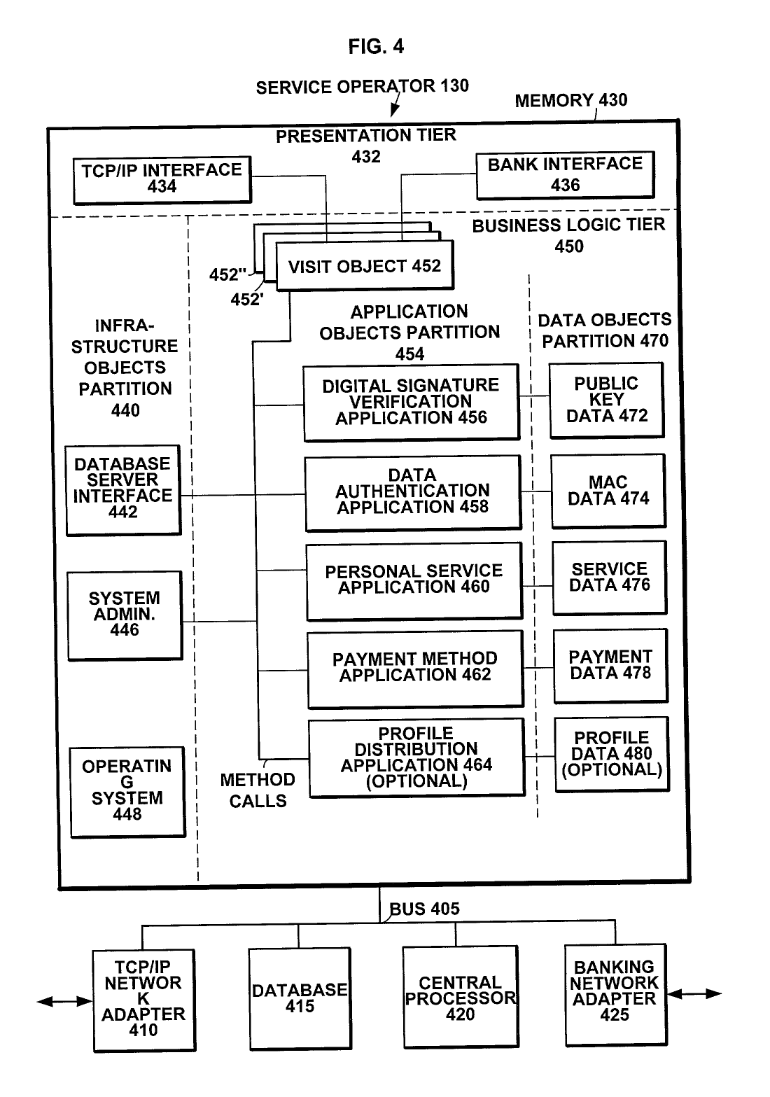

FIG. 4 shows the functional components of an exemplary service operator 130 arranged as an object model. The object model groups the object oriented software programs into components that perform the major functions and applications in service operator 130. The object model for memory 430 of service operator 130 employs a three-tier architecture that includes presentation tier 432, infrastructure objects partition 440, and business logic tier 450. The object model further divides business logic tier 450 into two partitions, application objects partition 454 and data objects partition 470.

Presentation tier 432 retains the programs that manage the device interfaces to service operator 130. In FIG. 4, presentation tier 432 includes network interface 434, and bank interface 436. A suitable implementation of presentation tier 432 may use Java servlets to interact with user device via the hypertext transfer protocol (“HTTP”). The Java servlets run within a request/response server that manages the exchange of messages between a user device and service operator 130. A Java servlet is a Java program that runs within a Web server environment. A Java servlet takes a request as input, parses the data, performs logic operations, and issues a response back to a user device. The Java runtime platform pools the Java servlets to simultaneously service many requests. Network interface 434 accepts request messages from a user device and passes the information in the request to visit object 452 for further processing. Visit object 452 passes result of that processing to network interface 434 for transmission back to the user device. Network interface 434 may also use network adapter 410 to exchange data with another user device. Bank interface 436 manages the exchange of messages between a financial institution and visit object 452 in a similar manner to network interface 434.

Infrastructure objects partition 440 retains the programs that perform administrative and system functions on behalf of business logic tier 450. Infrastructure objects partition 440 includes operating system 448, and an object oriented software program component for database server interface 442, and system administrator interface 446.

Business logic tier 450 in FIG. 4 includes multiple instances of visit object 452. A separate instance of visit object 452 exists for each bank interface 436 or network interface 434 session. Each visit object 452 is a stateful session bean that includes a persistent storage area from initiation through termination of the session, not just during a single interaction or method call. The persistent storage area retains information associated with the session.

When a user device sends a message to service operator 130, a message is sent to network interface 434 to invoke a method that creates visit object 452 and stores connection information in visit object state 452. Visit object 452 may, in turn, invoke a method in digital signature verification application 456 to verify the source that generated the message. Digital signature verification application 456 extracts the digital signature from the message and uses public key data 472 to decode the signature and verify the identity of the source that generated the message. Even though FIG. 4 depicts central processor 420 as controlling digital signature verification application 456, it is to be understood that the function performed by digital signature verification application 456 can be distributed to a separate system configured similarly to service operator 130.

When a user device sends a message to service operator 130, a message is sent to network interface 434 to invoke a method that creates visit object 452 and stores connection information in visit object state 452. Visit object 452 may, in turn, invoke a method in data authentication application 458 to authenticate a user device that generated the message. Data authentication application 458 uses MAC data 474 to authenticate the identity of the user device that generated the message. Even though FIG. 4 depicts central processor 420 as controlling data authentication application 458, it is to be understood that the function performed by data authentication application 458 can be distributed to a separate system configured similarly to service operator 130.

When a user device sends a message to service operator 130, a message is sent to network interface 434 to invoke a method that creates visit object 452 and stores connection information in visit object state 452. Visit object 452 may, in turn, invoke a method in personal service application 460 to perform the service-related operations including service negotiations, user profile access, the provision of services including personalized services. Personal service application 460 uses service data 476 to perform such operation. FIGS. 8A through 8C as well as the discussion above with reference to FIGS. 3B and 3C on the service operator's content and application 390 describe the service-related functions of personal service application 460. Even though FIG. 4 depicts central processor 420 as controlling personal service application 460, it is to be understood that the function performed by personal service application 460 can be distributed to a separate system configured similarly to service operator 130.

When a user device sends a message to service operator 130, a message is sent to network interface 434 to invoke a method that creates visit object 452 and stores connection information in visit object state 452. Visit object 452 may, in turn, invoke a method in payment method application 462 to compute a payment or fee for services rendered through use of payment data 478. Even though FIG. 4 depicts central processor 420 as controlling payment method application 462, it is to be understood that the function performed by payment method application 462 can be distributed to a separate system configured similarly to service operator 130.

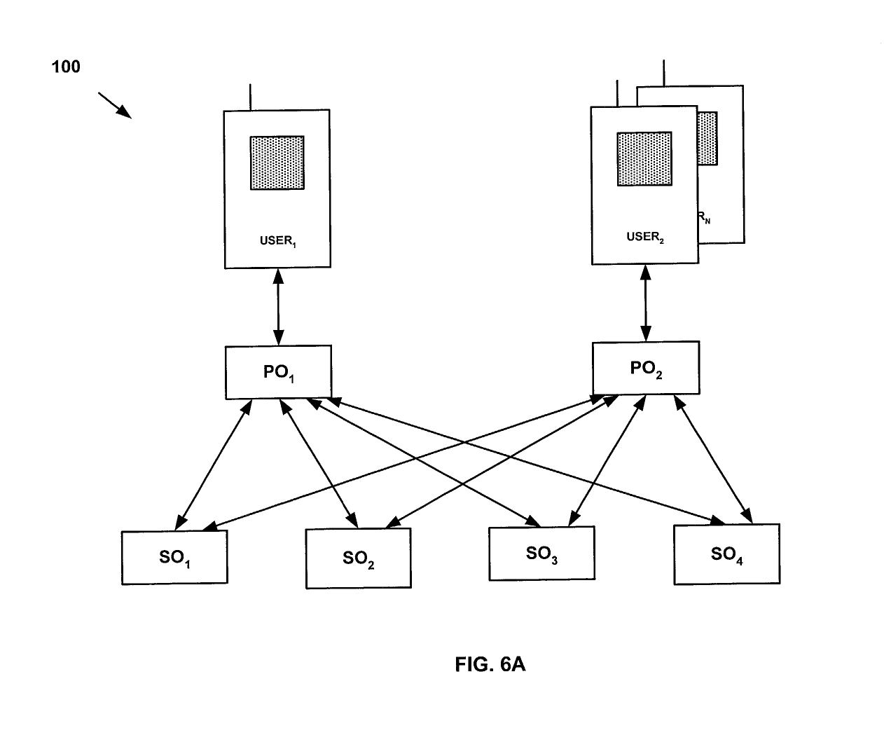

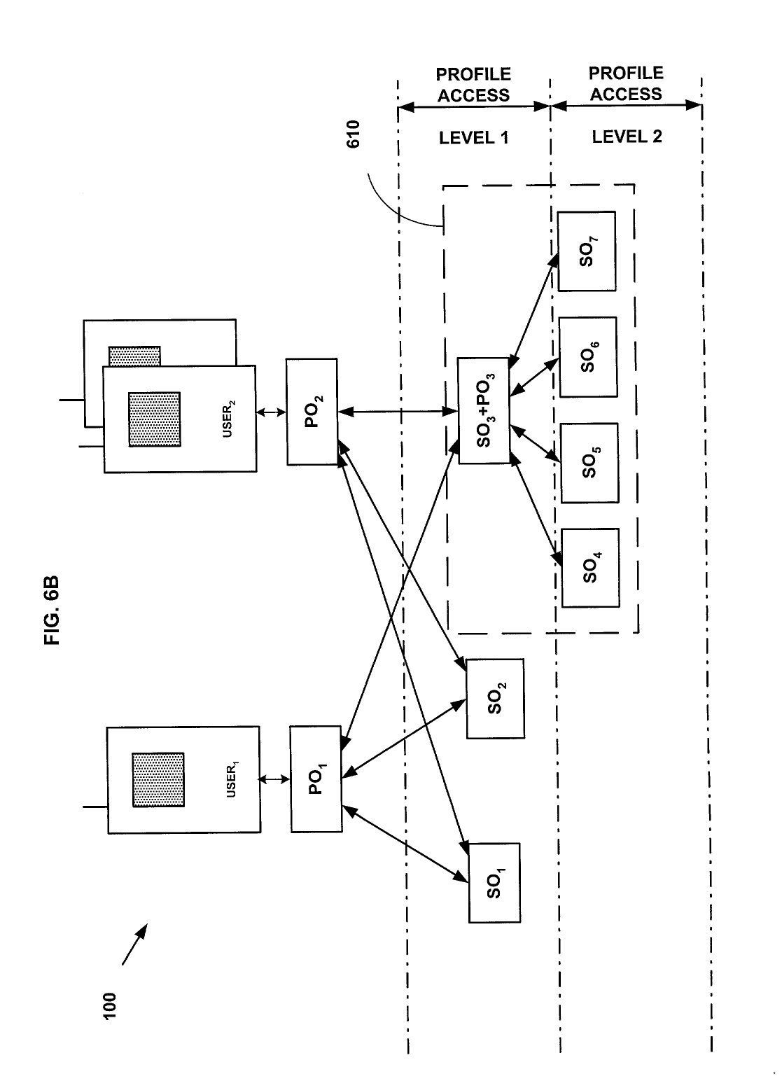

When a user device sends a message to service operator 130, a message is sent to network interface 434 to invoke a method that creates visit object 452 and stores connection information in visit object state 452. Visit object 452 may, in turn, invoke a method in profile distribution application 464 to control distribution/access of a user's profile information to lower level service operators through use of profile data 480. An example of a service operator which would implement profile distribution application is SO₃+PO₃ of FIG. 6B. Even though FIG. 4 depicts central processor 420 as controlling profile distribution application 464, it is to be understood that the function performed by profile distribution application 464 can be distributed to a separate system configured similarly to service operator 130.

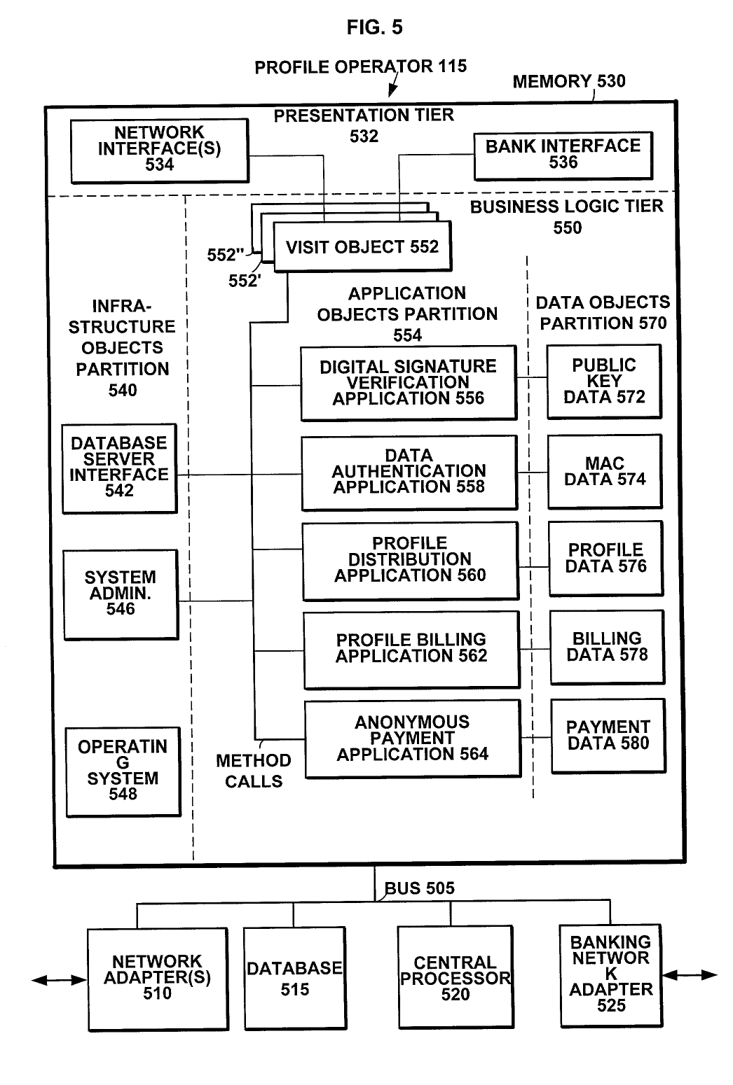

FIG. 5 shows the functional components of profile operator 115 arranged as an object model. The object model groups the object oriented software programs into components that perform the major functions and applications in profile operator 115. The object model for memory 530 of profile operator 115 employs a three-tier architecture that includes presentation tier 532, infrastructure objects partition 540, and business logic tier 550. The object model further divides business logic tier 550 into two partitions, application objects partition 554 and data objects partition 570.

Presentation tier 532 retains the programs that manage the device interfaces to profile operator 115. In FIG. 5, presentation tier 532 includes network interface 534, and bank interface 536. A suitable implementation of presentation tier 532 may use Java servlets to interact with user device via the hypertext transfer protocol (“HTTP”). The Java servlets run within a request/response server that manages the exchange of messages between a user device and profile operator 115. A Java servlet is a Java program that runs within a Web server environment. A Java servlet takes a request as input, parses the data, performs logic operations, and issues a response back to a user device. The Java runtime platform pools the Java servlets to simultaneously service many requests. Network interface 534 accepts request messages from a user device and passes the information in the request to visit object 552 for further processing. Visit object 552 passes result of that processing to network interface 534 for transmission back to the user device. Network interface 534 may also use network adapter 510 to exchange data with another user device. Bank interface 536 manages the exchange of messages between a financial institution and visit object 552 in a similar manner to network interface 534.

Infrastructure objects partition 540 retains the programs that perform administrative and system functions on behalf of business logic tier 550. Infrastructure objects partition 540 includes operating system 548, and an object oriented software program component for database server interface 542, and system administrator interface 546.

Business logic tier 550 in FIG. 5 includes multiple instances of visit object 552. A separate instance of visit object 552 exists for each bank interface 536 or network interface 534 session. Each visit object 552 is a stateful session bean that includes a persistent storage area from initiation through termination of the session, not just during a single interaction or method call. The persistent storage area retains information associated with the session.

When a user device sends a message to profile operator 115, a message is sent to network interface 534 to invoke a method that creates visit object 552 and stores connection information in visit object state 552. Visit object 552 may, in turn, invoke a method in digital signature verification application 556 to verify the source that generated the message. Digital signature verification application 556 extracts the digital signature from the message and uses public key data 572 to decode the signature and verify the identity of the source that generated the message. Even though FIG. 5 depicts central processor 520 as controlling digital signature verification application 556, it is to be understood that the function performed by digital signature verification application 556 can be distributed to a separate system configured similarly to profile operator 115.

When a user device sends a message to profile operator 115, a message is sent to network interface 534 to invoke a method that creates visit object 552 and stores connection information in visit object state 552. Visit object 552 may, in turn, invoke a method in data authentication application 558 to authenticate a user device that generated the message. Data authentication application 558 uses MAC data 574 to authenticate the identity of the user device that generated the message. Even though FIG. 5 depicts central processor 520 as controlling data authentication application 558, it is to be understood that the function performed by data authentication application 558 can be distributed to a separate system configured similarly to profile operator 115.

When a user device sends a message to profile operator 115, a message is sent to network interface 534 to invoke a method that creates visit object 552 and stores connection information in visit object state 552. Visit object 552 may, in turn, invoke a method in profile distribution application 560 to control distribution/access of a user's profile information to lower level service operators through use of profile data 576. FIGS. 8A through 8D describes, in greater detail, the process of profile distribution application 560. Even though FIG. 5 depicts central processor 520 as controlling profile distribution application 560, it is to be understood that the function performed by profile distribution application 560 can be distributed to a separate system configured similarly to profile operator 115.

When a user device sends a message to profile operator 115, a message is sent to network interface 534 to invoke a method that creates visit object 552 and stores connection information in visit object state 552. Visit object 552 may, in turn, invoke a method in profile billing application 562 to bill another party for services rendered (e.g., charge service operator for profile information) through use of billing data 578. Even though FIG. 5 depicts central processor 520 as controlling profile billing application 562, it is to be understood that the function performed by profile billing application 562 can be distributed to a separate system configured similarly to profile operator 115.

When a user device sends a message to profile operator 115, a message is sent to network interface 534 to invoke a method that creates visit object 552 and stores connection information in visit object state 552. Visit object 552 may, in turn, invoke a method in anonymous payment application 564 to provide trusted anonymous third payment services for a user through use of payment data 580. Even though FIG. 5 depicts central processor 520 as controlling anonymous payment application 564 it is to be understood that the function performed by anonymous payment application 564 can be distributed to a separate system configured similarly to profile operator 115.

It will be readily appreciated that service operator 130 and/or profile operator 115 may alternatively, or in addition to, the communication software discussed above, be equipped with a WML Script and WML functionality for communicating with the various system components (e.g., the user device, service operator, and/or profile operator).

FIG. 6A is an overview of one example of a service operator arrangement in which the user actions, via wireless portable device 110, are transmitted to service operators using a profile operator. As shown, each profile operator, e.g., PO₁ and PO₂, serves all the service operators SO₁ through SO₄ that the user may wish to use. To selectively control access and usage of profile information, viewpoint technology may be employed to enable different parts of the user profile to be accessed and used by different service operators. Viewpoints allow the service operator to access subsets of profile information for different purposes in different contexts.

In certain situations, a user or profile operator may wish to mask the user's identity from the service operators. Profile operators can be configured to perform such identity masking in at least two different levels. The one level of masking is pseudonymity which allows service operators to establish a relationship with the users while offering an opportunity to actively conceal or reveal elements of user identity. Another level of masking is complete anonymity which does not allow the service operators to identify the users. In both levels of identity masking, the profile operators can handle the billing of services.

From the profiling point of view, a significant difference between the two levels of identity masking is that pseudonymity allows each service operator to build its own profiles of user behavior since the service usage behavior of each individual user employing a service can be identified. However, anonymity does not allow service operators to build user profiles since the service operator cannot combine the usage data from multiple sessions for a particular user.

In order to receive profile information from a profile operator the service operators may be required to provide the profile operator with profile update information based on the user's service usage behavior. If the users are using the services anonymously, the service operators cannot build their own user profiles and the update information is the only way to develop the quality of profiles. Since the update information is valuable for the profile operators the service operators can be compensated by decreasing the price of the profile information in exchange for updates.

FIG. 6B is an overview of another example in which service operators may be hierarchically arranged to provide additional privacy levels or filtering in accordance with a further embodiment. As shown, service operators can be arranged hierarchically (SO₄-SO₇) such that higher level operators serve lower level operators. For example, with reference to 610, the service operator SO₃ serves the lower level service operators SO₄ through SO₇. In this kind of arrangement, the service operator SO₃ may also incorporate a profile operator PO₃ or its functions to provide profiling services for lower level service operators SO₄ through SO₇.

In this hierarchical arrangement, the level of identification information revealed to the lower level service operator may vary as well as the level of detail in the update information provided to the upper level operator. For example, the service operator SO₃ may be privy to a higher profile access level than the lower level service operators SO₄ through SO₇ since the service operator SO₃ may further filter a user's profile information provided to these lower level service operators. At the same time, the service operator SO₃ may receive user information from the lower level service operators SO₄ through SO₇ to update the user's profile.

The operator arrangements as shown in FIGS. 6A and 6B provide some potential advantages and disadvantages to the parties involved. For example, the advantages of these operator arrangements may, for example, include:

support for anonymity,

personalization over multiple service operators,

some service access information is available to profile operators without explicit feedback from the service operators,

personalization operator has access to usage data of all its customers,

a user can select his profile operator,

SO₃/PO₃ can analyze all visitors to a collection of SO₈ (SO₆-SO₇), which enables personalization at least across services with more complete data, and

hierarchical service operator arrangement supports affiliate companies.

Some potential disadvantages of such operator arrangements may, for example, include:

service operators have poorer data for personalization, and

a profile operator does not see all the users accessing a certain service operator.

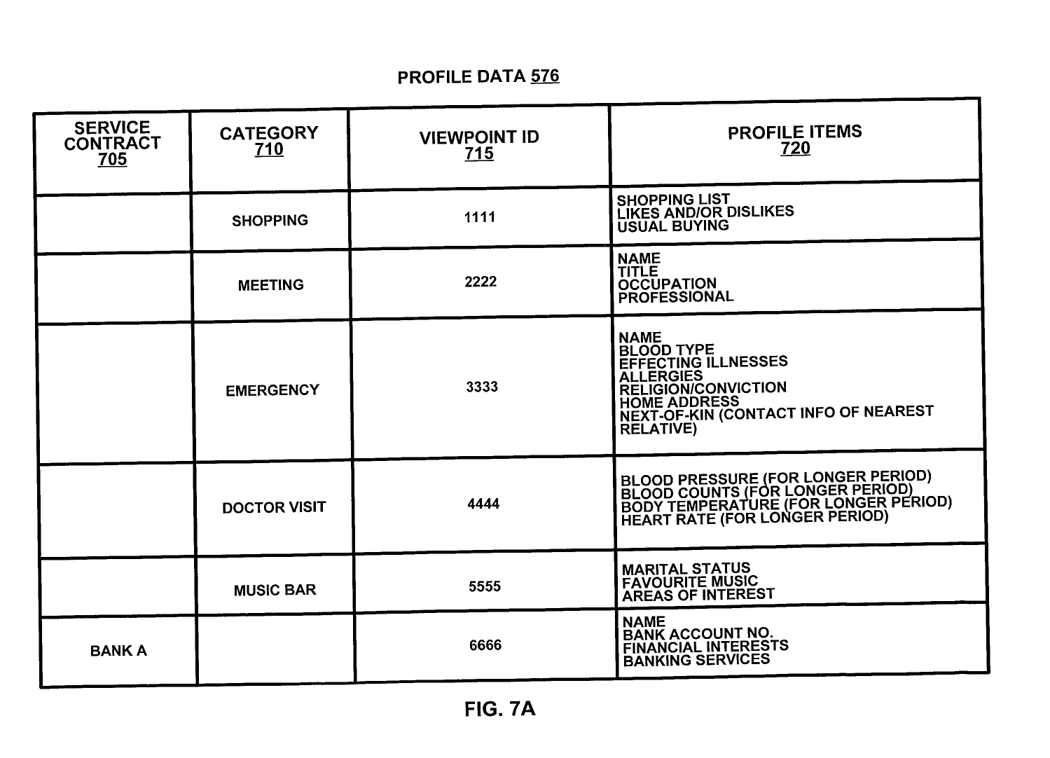

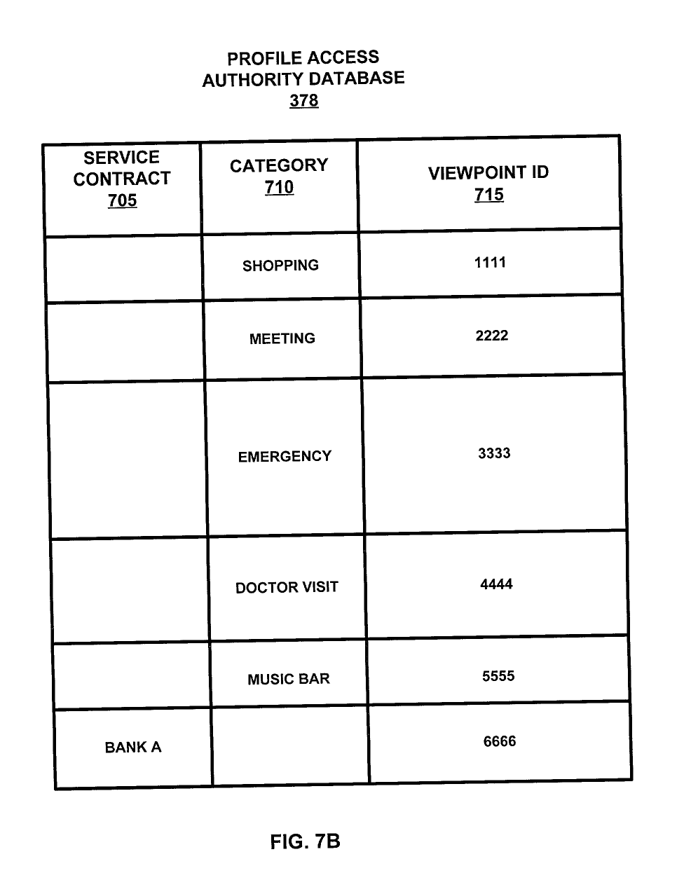

FIG. 7A illustrates an exemplary profile database 576 maintained or employed by profile operator 115. Profile database may include a service contract field 705, a category field 710, a viewpoint identifier (ID) field 715 and a profile items field 720. While the various fields and information are self-explanatory, a brief discussion of the database is provided below.

Service contract field 705 maintains an identity of those parties with pre-existing agreements with the user. These parties may have agreed upon the user profile subset to be provided to them. Category field 710 maintains information on the various categories of service contexts or categories a user may encounter. For example, a category may include shopping, meeting, emergency, doctor visit and music bar.

Viewpoint ID 715 maintains a viewpoint identifier for specifying a particular subset or viewpoint of a user's profile information.

Profile items 720 define various defined subsets or viewpoints of the user's profile information. These profile items are addressable by profile operator 115 according to a service contract, category or viewpoint ID. For example, in a shopping example, user device 110 may forward the category information (e.g., shopping) or a viewpoint ID (e.g., 1111) to service operator 130 which is then provided as part of a request to profile operator 115 for the user's profile information. Based on either the category or viewpoint identifier, profile operator 115 would provide the appropriate subset of profile information, e.g., the user's shopping list, the user's likes and/or dislikes and the user's usual buying habits.

FIG. 7B illustrates an exemplary profile access authority database 360 maintained or employed by user device 110 to determine a profile access authority or level. Database 360 may include a service contract field 725, a category field 735 and a viewpoint ID field 735, which maintain similar information as in fields 705, 170 and 715, respectively, as discussed above in FIG. 7A. The database 360 is used to determine a viewpoint or subset of profile information to be available to service operator 130 based whether the service operator has a contract with the user or based on the service category.

FIGS. 8A through 8D illustrate an exemplary process 800 by which a user controls a privacy level of communications with a service operator and controls access and usage of the user's profile information by the service operator via the user's Bluetooth-enabled portable device. The process 800 will be discussed with reference to FIGS. 1 and 2. In this example user device 110 is a Bluetooth-enabled portable wireless device and fixed position Bluetooth wireless device corresponds, e.g., to device 200 of FIG. 2. For the purposes of brevity, the fixed position Bluetooth wireless device will be referred hereafter as fixed position device 200. Fixed position device 200 enables location-based services as well as other services to be provided to the user. Communications between user device 110, service operator 130 and profile operator 115 may be facilitated through fixed position device 200 or other communications means, such as by cellular.

The process 800 commences at step 802 where user device 110 initiates service discovery automatically or upon a user request. At step 804, user device 110 sends periodic short range identity signal. At step 806, fixed position device 200 detects a user device 110's presence and, at step 810, sends an indication of service opportunit(ies) available from service operator 130. User device 110 discovers these opportunities at step 808, and sends a request for service-related information at step 812. Along with the request, user device 110 may or may not send an identifier depending upon the privacy level determined by the user device. Where user device 110 is simply discovering available service opportunities, the user device would unlikely send any identifier. In other words, the request for service information would be an anonymous request.

Fixed position device 200 receives the request at step 814 and, at step 820, sends the service-related information to user device 110. The service-related information may include service category, service description, requested viewpoint or any information which enables user device 110 to make a determination as to a privacy level and/or a profile access level. Alternatively, fixed position device 200 may pass the request to service operator 816 so that the service-related information is provided by service operator 130 through steps 816 and 818.

At step 824, user device 110 receives the service-related information. The information may be displayed to the user. At step 826, user device 110 determines whether to proceed with the service negotiation, for example, based upon a user selection. If user device 110 determines not to proceed, then the negotiations are terminated at step 830. Otherwise, the process 800 proceeds to step 828 in which user device 110 initiates a new session with profile operator 115.

At step 832, user device 110 requests session-based User ID from profile operator 115. As previously discussed, and as shown in FIG. 8B, user device 110 may send the request directly to profile operator, such as by cellular, or may send the request via fixed position device 200 which passes the request to the profile operator at step 834.

Profile operator 115, in steps 836 and 838, receives the request for a User ID and generates a session-based User ID. At step 840, profile server 115 sends the User ID to user device 110. As shown, profile operator 115 may send the User ID directly to user device 110, such as by cellular, or may send the request via fixed position device 200 which passes the request to the user device at step 841. Thereafter, user device 110 receives the user ID at step 814. The user ID enables user device to conduct pseudonymous communications with service operator 130. Although user device 110 may employ the user ID for more than one session, a new user ID is preferably generated for each session to prevent a service operator from collecting any profile information on the user.

At step 844, user device initiates a service session profile capturing operation which involves tracking the behavior and/or activities of the user on user device 110. This may involve, for example, clickstream recording, device adaptation tracking, location tracking and context tracking. The profile information of the user may be updated with the tracked information.

The session continues at step 846, at which time, user device 110 determines whether the user has a pre-existing relationship with service operator 130, such as a service contract with the service operator. If a service contract exists, user device 110 sends a profile access level or authority, which reflects a previously agreed upon profile access level or authority, (e.g., a predefined viewpoint identifier) to service operator 130 at step 852 via fixed position device 110 at step 854. Along with the profile access authority, user device 110 may or may not send an identifier depending on the privacy level determined by the user device. In such as situation, user device 110 may send the session-based user ID or, alternatively, an authenticated ID.

At step 856, service operator 130 receives the profile access level or authority and some user identifier (if transmitted), and requests the user profile from profile operator 115. At step 858, profile operator 115 receives the request, and retrieves a subset of the user's profile information according to the authorized profile access level. Thereafter, profile operator 115 sends the user profile to service operator 130 at step 860, and may charge or bill the service operator a fee for the profile information at step 874.

At step 862, service operator 130 receives the subset of the user's profile information, and provides personalized service(s) to the user according to the received subset of the profile information. At step 876, service operator 130 may send user information relating to the session, e.g., user activity or behavior, to profile operator 115 automatically or upon request by the profile operator. Profile operator 115 may then update the user's profile information with the user information provided by the service operator 130, and may also compensate the service operator for such information. The compensation may take the form of a discount to the fee charged by profile operator 115 for providing profile information to service operator 130. The discount may be increased accordingly based upon the amount of updated information or the number of times updated information is provided by service operator 130.

Continuing at steps 864 and 866, user device 110 receives the personalized service(s), via fixed position device 200. At step 868, user device 110 terminates the session. At step 870, user device 110 may send tracked user information captured by the session profile tracking operation initiated at step 844 to profile operator 115. At step 872, profile operator 115 updates the user's profile accordingly based on the received information.

Returning to step 850 of FIG. C, the process 800 proceeds to step 880 to continue determine the privacy level if no pre-existing relationship exists between service operator 130 and the user. At step 882, user device 110 determines a profile access level or authority to the user's profile information based on a service category or content or any information provided by service operator 130, such as a requested viewpoint, etc. At step 883, user device 110 sends the determined profile access level or authority via fixed position device 200 (step 884). Along with the profile access authority, user device 110 may or may not also send an identifier depending upon the privacy level determined by the user device.

At step 885, service operator 130 receives the user ID and profile access level, and requests the appropriate user profile from profile operator 115. At step 886, profile operator 115 receives the request, and retrieves a subset of the user's profile information according to the authorized profile access level. Thereafter, profile operator 115 sends the user profile to service operator 130 at step 887, and may charge or bill the service operator a fee for the profile information at step 894.

At step 888, service operator 130 receives the subset of the user's profile information, and provides personalized service(s) to the user according to the received subset of profile information. At step 895, service operator 130 may send user information relating to the session, e.g., user activity or behavior, to profile operator 115 automatically or upon a request by the profile operator. Profile operator 115 may then update the user's profile information with the user information provided by the service operator 130, and may also compensate the service operator for such information. As discussed above, the compensation may take the form of a discount to the fee charged by profile operator 115 for providing profile information to service operator 130.

Continuing at steps 889 and 890, user device 110 receives the personalized service(s), via fixed position device 200. At step 891, user device 110 terminates the session. At step 892, user device 110 may send tracked user information captured by the session profile tracking operation initiated at step 844. At step 893, profile operator 115 updates the user's profile accordingly based on the received information.

Although the process 800 shows fixed position device 200 as facilitating the provision of services between service operator 130 and user device 110, this device may be considered a component of service operator 130 where it performs service functions for the service operator.

Furthermore, FIGS. 8A through 8D provide one illustrative example of the privacy and profile access features in a specific network arrangement embodiment employing Bluetooth technology. It is apparent that these operations may be implemented between the various parties, e.g., a user device, a profile operator and a service operator, over any communication medium employing different network environments and/or different wireless technologies.

For example, instead of distributing the service-related functions between service operator 130 and fixed position device 200, the fixed position device may be configured as a stand-alone fixed or mobile device (e.g., another person's Bluetooth-enabled device) capable of performing all the operations performed by service operator 130 as discussed above in regard to FIGS. 8A through 8D. The stand-alone mobile device may, for example, be service operator 140 as shown in FIGS. 1A and 1B in which user device 110 communicates with service operator 140 over a personal area network (PAN).

Alternatively, user device 110 may conduct communications with service operator 130 and profile operator 115 over a general packet radio system (GPRS) or general system for mobile communications (GSM). At an initial stage, user device 110 may automatically or upon a user request send a request for service-related information (e.g., service category, service description, requested viewpoint, etc.) to service operator 130. The remaining operations performed by user device 110, service operator 130 and profile operator 115 thereafter would be similar to those discussed above in steps 826 through 893 of FIGS. 8A-8D.

Various illustrative examples of the operation of system network 100 in different service environments will be described below. These examples include a shopping scenario, a meeting scenario, a medical emergency scenario, a health care scenario and a music bar scenario. As discussed above, the privacy level and profile access level provided by the user may vary depending on the nature of the services.

### SHOPPING SCENARIO

In one example, a user operating a Bluetooth-enable user device 110 is shopping at a location (e.g., store, mall, etc.) having one or more fixed Bluetooth-enabled devices arranged at various locations within and/or in the vicinity of the shopping location. In this environment, the user may be provided services, such as information on sales or discounts on specific items, location of specific stores in the user's vicinity, advertising, and so forth based on the subset of the user's profile received from the profile server. Furthermore, the services may involve a transaction to purchase particular items. For transactions requiring payment by the user, the payment may be performed anonymously through a trusted third party, such as the user's profile operator.

### MEETING SCENARIO

In one example, a user operating a Bluetooth-enable user device 110 attends a meeting at a location having one or more fixed Bluetooth-enabled devices arranged at various locations within and/or in the vicinity of the meeting location. In this environment, the user may be provided services, such as document and file delivery, information on other people attending the meeting and whether every person has arrived, and so forth. Furthermore, the services may also include voting at the meeting.

In a further example, a user operating a Bluetooth-enabled user device 110 attends a meeting in which one or more people also have a Bluetooth-enabled device. As the user approaches within communication proximity with another person's device, user device 110 establishes a communication link with the other person's device (or vice-versa), e.g., service operator, to form a personal area network (PAN). In this environment, the services may include access to the other person's assets, such as personal information, software including games, etc., documents, and so forth. Additionally, the services may involve scheduling a further appointment with the other person, and so forth.

### MEDICAL EMERGENCY SCENARIO

In one example, a user operating a portable user device 110 is faced with a medical emergency. Through user device 110, the user can obtain services, such as medical consultation, directions to the closest hospital, calling for an ambulance, contacting the user's doctor and so forth.

### DOCTOR/HEALTH CARE SCENARIO

In one example, a user operating a Bluetooth-enable user device 110 visits the office of his/her doctor. The doctor's office has one or more fixed Bluetooth-enabled devices arranged at various locations within and/or outside the office. In this environment, the user may be provided services, such as medical consultation, information relating to the doctor or doctor's office, information relating to whether the doctor is on schedule with his/her appointments, information relating to new medical treatments, advertising for drugs or new medical procedures, and so forth.

Furthermore, the services may also include transaction-related services, such as scheduling a follow-up doctor's visit, obtaining a drug prescription and so forth.

### MUSIC BAR SCENARIO

In one example, a user operating a Bluetooth-enable user device 110 enters a music bar having one or more fixed Bluetooth-enabled devices arranged at various locations within the bar. In this environment, the user may be provided services, such as information services which may include advertising, general information about the music bar (e.g., background information, bar layout, etc.), information on other people at the music bar, information on music being played, information on the identities of music performers as well as the music currently playing, played or to be played at the music bar, a schedule of performances, general statistical information as to the people at the bar (e.g., 15 single females, 13 single males, etc.), and so forth.

Additional services may also include transaction-related services, such as music downloads, purchasing tickets to music performances, purchasing food and beverages, and so forth. Transactions requiring payment by the user may be conducted through anonymous payment with the assistance of a trusted third party or profile operator 115 acting as a trusted third party. The services capable of being provided by the service operator may be related or unrelated to the music bar environment.

In a further example, a user operating a Bluetooth-enabled user device 110 enters a music bar in which one or more people also have a Bluetooth-enabled device. As the user approaches within communication proximity with another person's device, user device 110 establishes a communication link with the other person's device (or vice-versa), e.g., service operator, to form a personal area network (PAN). In this environment, the services may include access to the other person's assets, such as personal information, software including games, etc., documents, and so forth. Additionally, the services may involve playing a game with the other person over the personal area network, setting up a date with the other person and so forth.

While a specific communication arrangement is discussed in these illustrative scenarios, the service operator may provide the services to the user over any communication network arrangement, such as a personal area network (PAN), the Internet, wireless communication network or a combination thereof.

Although specific embodiments of the invention have been disclosed, it will be understood by those having skill in the art that changes can be made to that the specific embodiments without departing from the spirit and the scope of the invention.

What is claimed is:

1. A method of managing user privacy in a network environment, comprising:
recognizing one or more service opportunities of a service operator on a user device operated by a user;
determining a privacy level at which communications is conducted with a service operator; and
conducting the communications with the service operator at the privacy level.

2. The method according to claim 1, wherein the recognizing comprises automatically discovering the one or more service opportunities.

3. The method according to claim 2, wherein the user device is a BLUETOOTH—enabled wireless communications device which automatically discovers service opportunities.

4. The method according to claim 1, wherein the recognizing comprises anonymously obtaining information relating to the one or more service opportunities.

5. The method according to claim 4, wherein the information relating to the one or more service opportunities comprises one of a service category, a service description and a requested viewpoint.

6. The method according to claim 5, further comprising allowing the service provider to obtain access to a subset of profile information of the user according to the service category.

7. The method according to claim 6, further comprising providing personalized service to the user according to the subset of profile information.

8. The method according to claim 5, further comprising allowing the service provider to obtain a subset of profile information of the user according to the requested viewpoint.

9. The method according to claim 8, further comprising providing personalized service to the user according to the subset of profile information.

10. The method according to claim 1, wherein the privacy level includes one of Anonymous, Pseudonymous, Anonymous transaction and Authenticated.

11. The method according to claim 1, wherein the determining a privacy level determines a privacy level based on the nature of the service negotiations with the service operator.

12. The method according to claim 1, wherein the determining a privacy level determines a privacy level based on a level of privacy in one or more prior transactions with the specific service operator.

13. The method according to claim 1, wherein the determining a privacy level determines a privacy level based on the identity of the service operator.

14. The method according to claim 1, wherein the determining a privacy level determines a privacy level based on user-defined parameters.

15. The method according to claim 1, wherein the determining a privacy level determines a privacy level based on the user's prior behavior or activity.

16. The method according to claim 1, further comprising obtaining a user identifier to conduct pseudonymous communications with the service operator relating to the one or more service opportunities.

17. The method according to claim 12, further comprising allowing the service provider to obtain access to a predefined subset of profile information.

18. The method according to claim 1, further comprising allowing the service provider to obtain access to a subset of profile information.

19. The method according to claim 18, wherein the service provider is charged a fee for obtaining the subset of profile information.

20. The method according to claim 18, wherein the service provider obtains the subset of profile information from a profile operator remotely located from the user device.

21. The method according to claim 20, wherein the allowing the service provider comprises:
determining a profile access level; and
transmitting the profile access level to the service operator,
wherein the service operator obtains a subset of profile information from a profile operator according to the profile access level.

22. The method according to claim 21, wherein the determining a profile access determines the profile access level according a service category of the one or more service opportunities.

23. The method according to claim 21, wherein the determining a profile access determines the profile access level based upon a prior arrangement between the service operator and the user.

24. The method according to claim 18, further comprising updating the profile information of the user.

25. The method according to claim 24, wherein the profile information of the user is updated based on user information provided by the service operator.

26. The method according to claim 25, wherein the service operator is compensated for providing the user information.

27. The method according to claim 24, further comprising tracking user activity on the user device, wherein the profile information of the user is updated based on the tracked user activity.

28. The method according to claim 1, wherein the service opportunities recognized by the user are dynamically changed by the service provider.

29. The method according to claim 28, wherein the service opportunities recognized by the user are dynamically changed by the service provider according to profile information of the user.

30. The method according to claim 1, wherein the user device and the service operator communicate across a personal area network.

31. The method according to claim 1, wherein the user device comprises a mobile wireless device.

32. The method according to claim 1, further comprising receiving service from the service operator.

33. The method according to claim 32, wherein payment for the service obtained by the user is conducted anonymously.

34. A method of managing user privacy in a network environment through a distributed user system including a user device and profile operator, comprising:
recognizing one or more service opportunities of a service operator on a user device operated by a user;
determining a privacy level at which communications is conducted with a service operator relating to the one or more service opportunities on the user device;
determining a profile access level on the user device;
transmitting the profile access level to the service operator; and
enabling the service operator to obtain a subset of profile information of the user according to the profile access level.
